(19) United States
(12) Patent Application Publication
(10) Pub. No.: US 2003/0222569 A1
(43) Pub. Date: Dec. 4, 2003

(54) Light source for condensing light

(76) Inventors: Tsung-Yin Chen, Taipei (TW); Yeh-Te Lee, Taipei (TW)

Correspondence Address: BIRCH STEWART KOLASCH & BIRCH, PO BOX 747, FALLS CHURCH, VA, 22040-0747, US

(21) Appl. No.: 10/449,078

(22) Filed: Jun. 2, 2003

(30) Foreign Application Priority Data
Jun. 3, 2002 (TW) 091111909

(51) Int. Cl. H01J 1/62

(52) U.S. Cl. 313/493

(57) ABSTRACT

A light source with a function of condensing light comprises a radiating area, a penetrable layer, and a condensing layer. The penetrable layer comprises a first inner tube and a first outer tube, and any cross section, which is vertical to the central axis of the light source, of the first inner tube and the first outer tube has the same first cross-section curvature. The condensing layer couples to the penetrable layer and together they cover the radiating area inside the light source. Any cross section, which is vertical to the central axis, of the second inner tube of the condensing layer has the first cross-section curvature; the cross section, which is vertical to the central axis, of the second outer tube of the condensing layer has at least a second cross-section curvature, and the second cross-section curvature is greater than the first cross-section curvature.

This application claims the benefit of Taiwan application Serial No. 091111909, filed Jun. 3, 2002.

### BACKGROUND OF THE INVENTION

1. Field of the Invention

The invention relates in general to a light source, and more particularly to an illumination with a function of condensing light.

2. Description of the Related Art

General scanners include at least a scanning platform, an illuminating device, and a stepping motor. The illuminating device is for scanning papers on the scanning platform; and the stepping motor is for driving the illuminating device gradually to move during the scanning process. The illuminating device comprises a light source, a lens, and a sensitized component. When scanning a paper, the light source provides light beams to illuminate the paper. The light beams reflected from the paper are collected and focused to form a duplicated image on the sensitized component. The component can get a partial image of the whole paper. After that, the stepping motor drives the illuminating device to move gradually to scan the portion which is not scanned yet. After all images are gathered together by the scanner, the whole image of the paper can then be revealed.

Referring to FIG. 1A, it illustrates a lateral view of a light source applied in general scanners. In FIG. 1A, a light source 102 is a tubular lamp, which has a radiating area 101, and a penetrable layer 109 with even thickness. The radiating area, which is covered in the light source 102 by the penetrable layer 109, is for supplying light. The penetrable layer 109 is provided with an inner tube 108 and an outer tube 110. When the central axis L of the light source 102 is set as a base, an inner diameter a and an outer diameter b respectively corresponding to the inner tube 108 and the outer tube 110 are determined. The value of the outer diameter b is bigger than the inner diameter a, and the even thickness of the transparent layer is (b-a). In addition, the tubular lamp can be a cold cathode fluorescent lamp (CCFL).

Referring to FIG. 1B, it illustrates a cross-sectional view of a paper illuminated by a light source along the dashed line 1B-1B vertical to the central axis L in FIG. 1A. In FIG. 1 B, the central axis L of the light source 102 is normally parallel to the surface of a paper 104, i.e. the central axis L is parallel to the scan line on the paper 104. The cross section of the inner tube 108 and the cross section of the outer tube 110 are two concentric circles having the central axis L as the same axle center. Namely, the cross sections of the inner tube 108 and the outer tube 110 have the same cross-section curvature.

Taking the whole illumination of the light source 102 as l, the beams of light provided by the radiating area 101 penetrate the penetrable layer 109 in the way of 360-degree divergent dispersion and emit outside. The scanned pixel 106, which is on the paper 104 illuminated by the light source 102, is taken as an example. Since the angle of the light beams illuminating on the scanned pixel 106 is Θ, the effective surface measure of the inner tube penetrated by illuminating beams on the scanned pixel 106 is (Θ/2 n) of the surface measure of the whole inner tube; and the illumination on the scanned pixel 106 is l*(Θ/2 n), that is also called the luminance of the scanned pixel 106. If the luminance of the scanned pixel 106 (i.e. the illumination on the scanned pixel 106) can be increased, then the luminance of the whole scanned image can then be raised, and the quality of the scan can be raised also. Additionally, the time of exposure for a sensitized component can be shortened, and thus the scanning time can be shortened as well.

Furthermore, during the process of forming the image, since optical path differences can cause the problem of decreased light, the luminance around the two ends of a tubular light source is lower than the luminance of the middle part of the light source. Therefore, the luminance of the middle part of the image collected by the sensitized component is higher than that on the two sides of the image. Hence, the scanning quality is influenced extremely.

### SUMMARY OF THE INVENTION

It is therefore an object of the invention to provide a light source with the function of condensing light. The effect of condensing light can be achieved by the design that results in the cross-section curvature of the outer tube of a condensing layer being greater than the cross-section curvature of the inner one. The luminance of the whole image can be improved by increasing the illumination coming from the light source on the scanned pixel. In addition, the time of exposure for a sensitized component can be shortened, and the time required for the scanning process can also be shortened.

The invention achieves the above-identified objects by providing a light source with the function of condensing light. The light source, which is provided with a central axis, comprises a radiating area, a penetrable layer, and a condensing layer, wherein [he radiating area is for providing light and the penetrable layer is for enabling the light to penetrate through to the outside. The penetrable layer consists of a first inner tube and a first outer tube. Any cross section, which is vertical to the central axis, of the first inner and outer tubes has the same first cross-section curvature. The condensing layer couples to the penetrable layer and together covers the radiating area inside the light source. The condensing layer consists of a second inner tube and a second outer tube. The second inner tube couples with the first inner tube, and the cross-section curvature of any cross section, which is vertical to the central axis, of the second inner tube is the same as the first cross-section curvature. The second outer tube couples with the first outer tube. The cross section, vertical to the central axis, of the second outer tube has at least a second cross-section curvature, and the second cross-section curvature is greater than the first one. Thus, the light can be condensed outside the condensing layer.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1A illustrates a lateral view of a light source applied in general scanners;

FIG. 1B illustrates a cross-sectional view of a paper illuminated by a light source along the dashed line 1B-1B vertical to the central axis L in FIG. 1A;

FIG. 2A illustrates a lateral view of a light source with a function of condensing light according to the preferred embodiment 1 of the invention;

FIG. 2B illustrates a cross-sectional view of a paper illuminated by a light source along the dashed line 2B-2B vertical to the central axis L in FIG. 2A;

FIG. 3A illustrates a lateral view of a light source with a function of condensing light according to the preferred embodiment 2 of the invention;

FIG. 3B illustrates a cross-sectional view of a paper illuminated by a light source along the dashed line 3B-3B vertical to the central axis L in FIG. 3A;

### DESCRIPTION OF THE PREFERRED EMBODIMENT

The invention especially provides a light source with a function of condensing light, and the light source includes a radiating area, a penetrable layer, and a condensing layer, wherein the penetrable layer consists of a first inner tube and a first outer tube. Any cross section, vertical to the central axis, of the first inner and outer tubes has the same first cross-section curvature. The condensing layer couples to the penetrable layer and together they cover the radiating area inside the light source. The cross-section curvature of any cross section, vertical to the central axis, of the second inner tube of the condensing layer is the same as the first cross-section curvature. The cross section, vertical to the central axis, of the second outer tube of the condensing layer has at least a second cross-section curvature, and the second cross-section curvature is greater than the first one. In this manner, light can be condensed outside the condensing layer, and the luminance of the whole image can be improved by increasing the illumination on the scanned pixel. In addition, the time of exposure for a sensitized component can be shortened, and thus, the scanning time can also be shortened.

The practical applications of the invention are illustrated in the following two embodiments and the attached figures.

Embodiment One

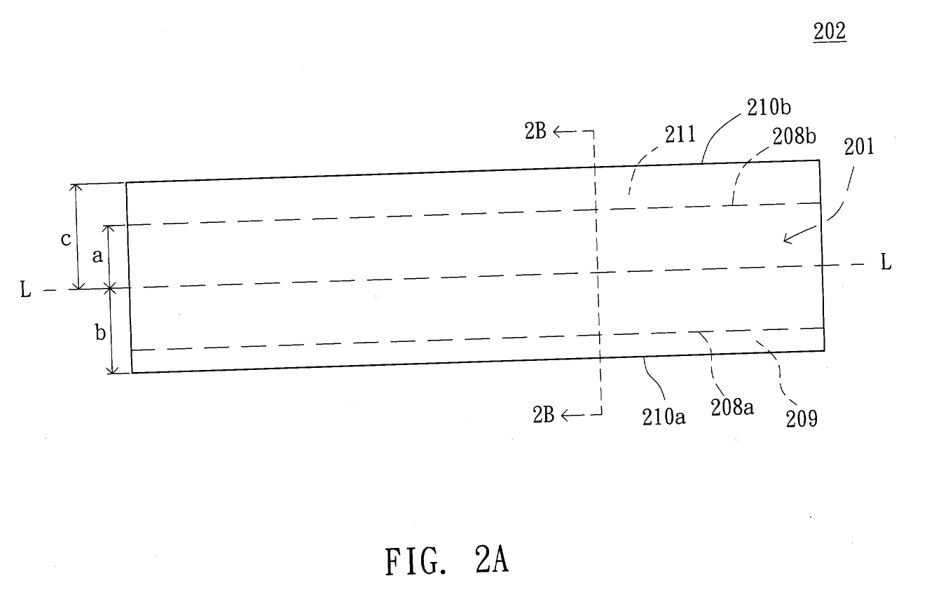

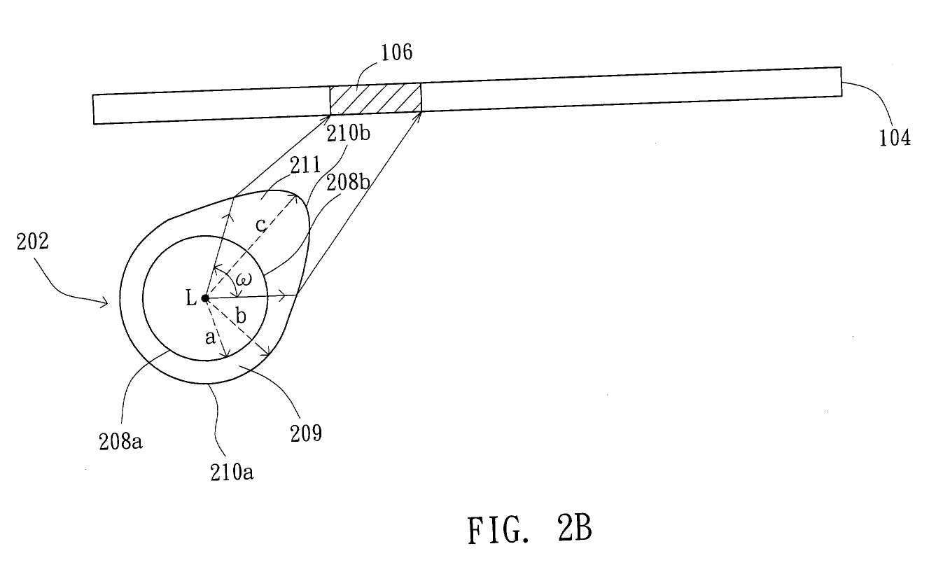

Referring to FIG. 2A, it illustrates a lateral view of a light source with a function of condensing light according to the preferred embodiment 1 of the invention. In FIG. 2A, a light source 202 includes a radiating area 201, and a penetrable layer 209 coupled with a condensing layer 211. The penetrable layer 209 and the condensing layer 211 together cover the radiating area 201 in the light source 202, wherein the radiating area 201 is used for supplying light. The penetrable layer 209 has a first inner tube 208a and a first outer tube 210a; and the condensing layer is provided with a second inner tube 208b and a second outer tube 210b. The first inner tube 208a couples with the second inner tube 208b to be the inner tube of the light source 202; and the first outer tube 210a couples with the second outer tube 210b to be the outer tube of the light source 202. When the central axis L of the light source 202 is set as the base, the first inner tube 208a and the second inner tube 208b have the same inner diameter a. The first outer tube 210a has a first outer diameter b, and the second outer tube 210b has a second outer diameter c, where c>b>a. The second outer diameter c is the maximum distance between the second outer tube 210b and the central axis L, and the distance between any point on the second outer tube 210b and the central axis L is greater than the value of b.

Furthermore, the inner diameter a, the first outer diameter b, and the second outer diameter c in the light source 202 are fixed values, which enables the light source 202 to be a tube with even thickness. Also, the thickness distribution of the tube of the light source 202 is different from the average thickness of the tube in the light source 102.

Referring to FIG. 2B, it illustrates a cross-sectional view of a paper illuminated by a light source along the dashed line 2B-2B vertical to the central axis L in FIG. 2A. In FIG. 2B, the central axis L of the light source 202 is normally parallel to the surface of the paper 104, i.e. the central axis L is parallel to the scan line on the paper 104. The cross section of the first inner tube 208a and the cross section of the second inner tube 208b are two concentric circles having the central axis L as the same axle center, and the cross section of the first outer tube 210a is an arc having the central axis L as the axle center. Namely, the cross sections of the first inner tube 208a, the second inner tube 208b, and the first outer tube 210a have the same first cross-section curvature.

It is noted that the second outer tube 210b of the condensing layer 211 of this invention has a second cross-section curvature. The second cross-section curvature is greater than the first cross-section curvature of the second inner tube 208b, which enables the light beams to be collected and condensed on the paper 104 after penetrating the condensing layer 211, and the condensing function can improve the luminance on the paper 104.

It is also noted that the light source 202 is a tube with even thickness, so that any cross section, vertical to the central axis L, of the first inner tube 208a, the second inner tube 208b, and the first outer tube 210a has the same curvature with the first cross-section curvature. Also, any cross section, vertical to the central axis L, of the second outer tube 210b has a second cross-section curvature, and the second cross-section curvature is greater than the first cross-section curvature.

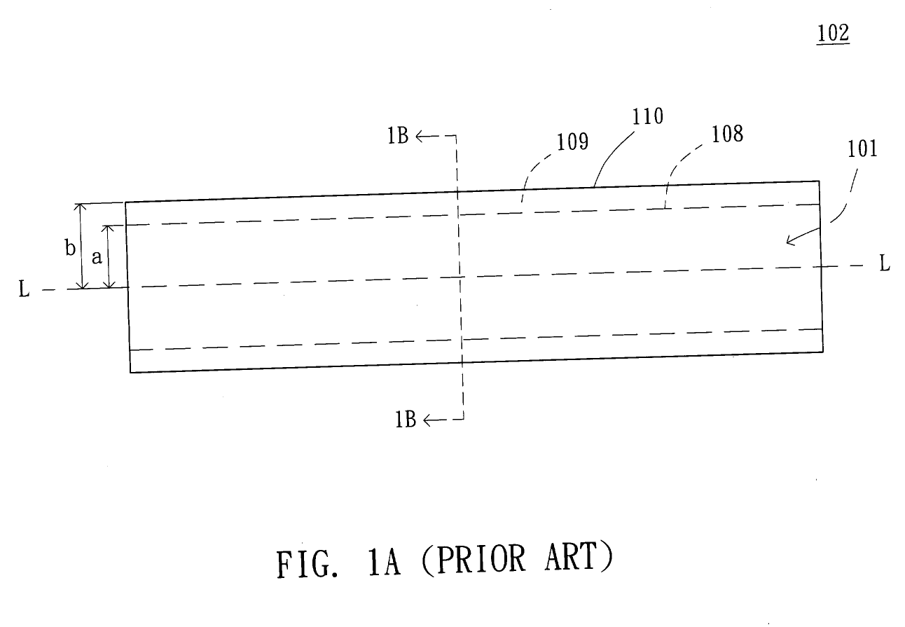

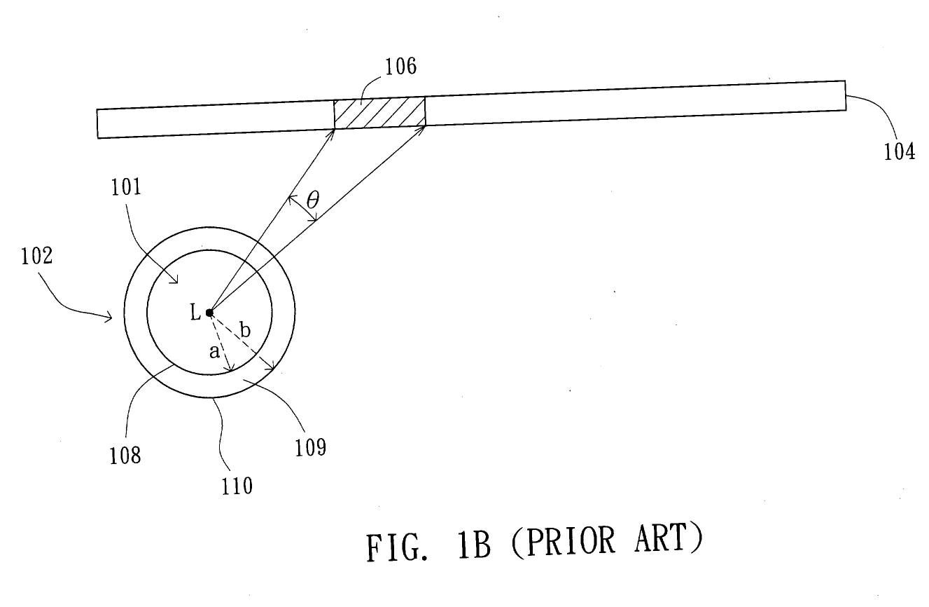

Taking the whole illumination of the light source 202 as 1, the beams of light provided by the radiating area 201 penetrate the penetrable layer 209 and the condensing layer 211 in the way of 360-degree divergent dispersion and emit outside. Furthermore, the scanned pixel 106, which is on the paper 104 illuminated by the light source 202, is taken as an example. Since the second cross-section curvature of the second outer tube 210b is greater than the first cross-section curvature of the second inner tube 208b of the condensing layer 211, the light beams start to condense after penetrating the penetrable layer 211. Then the angle of the beams illuminating on the scanned pixel 106 is enlarged to become A, where the value of ω is greater than the value of Θ in the FIG. 1B. Therefore, the effective surface measure of the inner tube penetrated by illuminating beams on the scanned pixel 106 is increased to (ω/2 n) of the surface measure of the whole inner tube; and the illumination on the scanned pixel 106 is also increased to l*(ω/2 n). Also, the value of l*(ω/2 n) is greater than the value of l*(Θ/2 n) illuminated on the scanned pixel 106 in FIG. 1B. Thus, by changing the curvature of the outer tube of a light source, the light beams emitting from the light source can achieve the function of condensing or dispersing.

Therefore, the design of the condensing layer 211 of the light source 202 in this invention can increase the illumination of the scanned pixel 106, i.e. the luminance on the scanned pixel 106. Then, the luminance of the whole scanned image can then be raised, and so can the quality of the scanning. Additionally, the time of exposure for a sensitized component can be shortened, and the scanning time can be shortened as well.

Embodiment Two

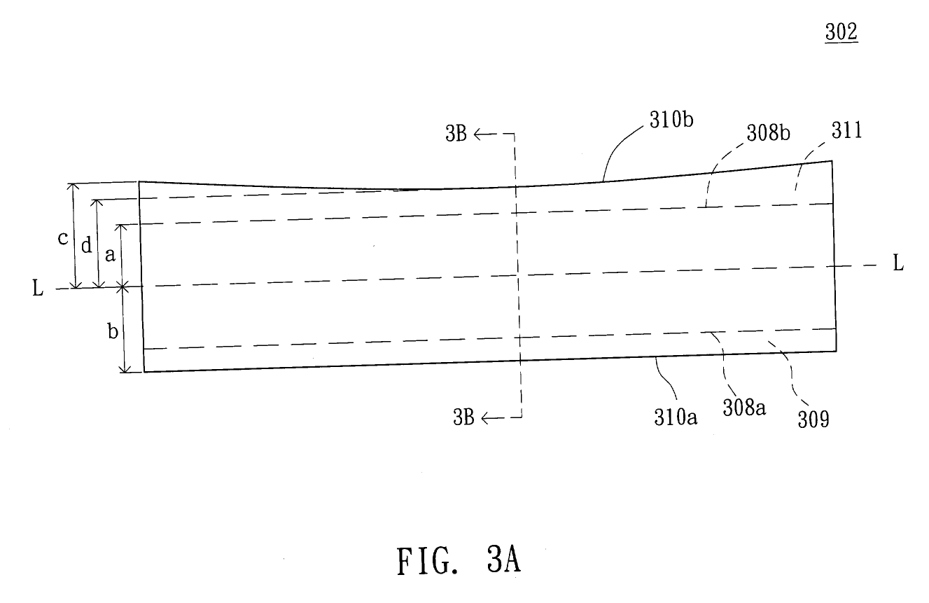

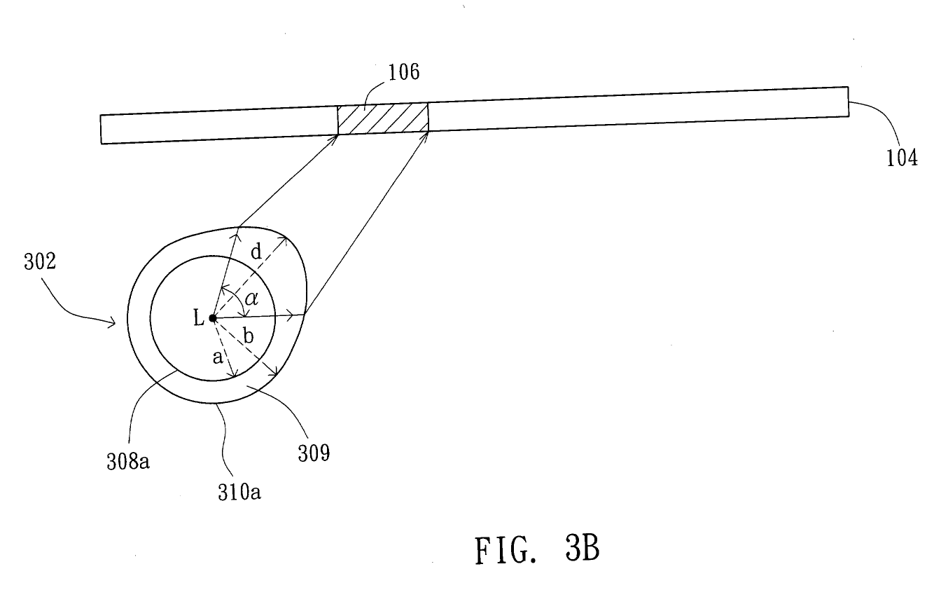

Referring to FIG. 3A, it illustrates a lateral view of a light source with a function of condensing light according to the preferred embodiment 2 of the invention. In FIG. 3A, a light source 302 includes a radiating area 301, and a penetrable layer 309 coupled with a condensing layer 311. The penetrable layer 309 and the condensing layer 311 together cover the radiating area 301 in the light source 302, wherein the radiating area 301 is for supplying light. The penetrable layer 309 has a first inner tube 308a and a first outer tube 310a; and the condensing layer 311 is provided with a second inner tube 308b and a second outer tube 310b. The first inner tube 308a couples with the second inner tube 308b to be the inner tube of the light source 302; and the first outer tube 310a couples with the second outer tube 310b to be the outer tube of the light source 302.

When the central axis L of the light source 302 is set as the base, the first inner tube 308a and the second inner tube 308b have the same inner diameter a. The first outer tube 310a has a first outer diameter b; both ends of the second outer tube 210b of the light source 302 have a second outer diameter c; and the center of the second outer tube of the light source 302 has another second outer diameter d, where c>d>b>a.

The second outer diameter d is the maximum distance between the center of the second outer tube 310b of the light source 302 and the central axis L, and the second outer diameter c is the maximum distance between two sides of the second outer tube 310b of the light source 302 and the central axis L. The distance between any point on the second outer tube 310b and the central axis L is greater than the value of b, and the values of the second outer diameters of the second outer tube increase gradually from the center to the ends of the light source 302 This enables the light source 302 to become a tube in which the middle part is slimmer than two ends, which is much different from the light source 102 of the same size.

Since the lateral view of the two ends of the light source 302 is the same as that of the light source in FIG. 2B, it will not be repeated here.

Referring to FIG. 3B, it illustrates a cross-sectional view of a paper illuminated by a light source along the dashed line 3B-3B vertical to the central axis L in FIG. 3A. In FIG. 3B, the central axis L of the light source 302 is normally parallel to the surface of a paper 104, i.e. the central axis L is parallel to the scan line on the paper 104. The cross section of the first inner tube 308a and the cross section of the second inner tube 308b are two concentric circles having the central axis L as the same axle center, and the cross section of the first outer tube 310a is an arc by using the central axis L as the axle center. Namely, the cross sections of the first inner tube 308a, the second inner tube 308b, and the first outer tube 310a have the same first cross-section curvature.

It is noted that the second outer tube 310b of the condensing layer 311 of this invention has a second cross-section curvature. The second cross-section curvature is greater than the first cross-section curvature, and thus enabling the light beams to be collected and condensed on the paper 104 after penetrating the condensing layer 311. Namely, the condensing function of the condensing layer 311 improves the luminance on the paper 104. Besides, the second cross-section curvature of the second outer tube 310b of the condensing layer 311 on the middle of the light source 302 is smaller than the second cross-section curvature of the second outer tube 310b of the condensing layer 311 on both ends of the light source 302. The values of the second cross-section curvatures of the second outer tube 310b of the condensing layer 311 increase gradually from the center to the ends of the light source 302. The greater the cross-section curvature of the second outer tube 310b of the condensing layer 311 results in the better condensing effect. Therefore, the condensing effect of the condensing layer 311 on the two ends of the light source 302 is better than that on the middle of the light source 302. The design of such a light source 302 can solve the problem of decreased light caused by optical path differences, and can equal the luminance of the middle part and the two sides of the image collected by the sensitized component. Then, the quality of the scanning can be improved.

In addition, any cross section, vertical to the central axis L, of the first inner tube 308a, the second inner tube 308b, and the first outer tube 310a has the same curvature with the first cross-section curvature. Any cross section, vertical to the central axis L, of the second outer tube 310b has a second cross-section curvature, and the second cross-section curvature is greater than the first cross-section curvature.

Taking the whole illumination of the light source 302 also as l, the light beams provided by the radiating area 301 penetrate the penetrable layer 309 and the condensing layer 311 in the way of 360-degree divergent dispersion and emit outside. The scanned pixel 106, which is on the paper 104 illuminated by the light source 302, is taken as an example. Since the second cross-section curvature of the second outer tube 310b is greater than the first cross-section curvature of the second inner tube 308b of the condensing layer 311, the light beams start to condense after penetrating the penetrable layer 311. Then the angle of beams illuminating on the scanned pixel 106 is enlarged to α, where ω>α>Θ. Therefore, the effective surface measure of the inner tube penetrated by illuminating beams on the scanned pixel 106 is increased to (α/2 n) of the surface measure of the whole inner tube; and the illumination on the scanned pixel 106 is also increased to l*(α/2 n), where l*(ω/2 n)>l*(α/2 n)>l*(Θ/2 n).

Therefore, the design of the condensing layer 311 of the light source 302 in this invention can increase the illumination of the scanned pixel 106, that is the luminance on the scanned pixel 106. Then, the luminance of the whole scanned image can then be raised, and so can the quality of the scan. Additionally, the time of exposure for a sensitized component can be shortened, and the time of scanning can be shortened also.

In addition, the design, whereby the values of the second cross-section curvatures of the second outer tube 310b of the condensing layer 311 increase gradually from the center to the ends of the light source 302, can solve the problem of decreased light caused by optical path differences, and can achieve equal luminance on the whole light source.

However, it is to be understood that the invention is not limited to the disclosed embodiments. For example, the light source can be a cold cathode fluorescent lamp (CCFL), a hot cathode fluorescent lamp, or other tubular light sources.

Disclosed above is a light source with the function of condensing light. The design, whereby the value of the second cross-section curvature of the second outer tube of the condensing layer is greater than the value of the first cross-section curvature of the second inner tube, can achieve a condensing effect. The luminance of the whole scanned image can then be raised, so does the quality of scan. Additionally, the time of exposure for a sensitized component can be shortened, and the scanning time can be shortened as well.

While the invention has been described by way of examples and in terms of the preferred embodiments, it is to be understood that the invention is not limited to the disclosed embodiments. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light source with a function of condensing light, the light source provided with a central axis, and comprising:
a radiating area for providing light;
a penetrable layer for enabling light to penetrate through to outside, the penetrable layer comprising a first inner tube and a first outer tube, any cross section, vertical to the central axis, of the first inner tube and the first outer tube having the same first cross-section curvature; and
a condensing layer, which couples to the penetrable layer and together cover the radiating area inside the light source, wherein the condensing layer comprises a second inner tube and a second outer tube; the second inner tube couples with the first inner tube; any cross section, vertical to the central axis, of the second inner tube has the first cross-section curvature; the second outer tube couples with the first outer tube; the cross section, vertical to the central axis, of the second outer tube has at least a second cross-section curvature; and the second cross-section curvature is greater than the first cross-section curvature, so that light can be condensed outside the condensing layer.

2. A light source according to claim 1, wherein any cross section, which is vertical to the central axis, of the light source has the second cross-section curvature

3. A light source according to claim 1, wherein a first outer diameter between the first outer tube and the central axis is determined; the maximum distance between the second outer tube and the central axis determines a second outer diameter; and the second outer diameter is greater than the first outer diameter.

4. A light source according to claim 1, wherein the second cross-section curvature of the middle of the light source is smaller than the second cross-section curvature of both ends of the light source.

5. A light source according to claim 4, wherein the maximum distance between the second outer tube of the middle of the light source and the central axis is smaller than the maximum distance between the second outer tube of both ends of the light source and the central axis.

6. A light source according to claim 1, wherein the light source is a tubular light source.

7. A light source according to claim 1, wherein the light source is a cold cathode fluorescent lamp (CCFL).

8. A light source with a function of condensing light, wherein the light source is provided with a central axis, and comprises:
a radiating area for providing light;
a penetrable layer for enabling light to penetrate through to outside, wherein the penetrable layer comprises a first inner tube and a first outer tube, and any cross section, vertical to the central axis, of the first inner tube and the first outer tube has the same first cross-section curvature; and
a condensing layer, which couples to the penetrable layer and together cover the radiating area inside the light source, wherein the condensing layer comprises a second inner tube and a second outer tube, the second inner tube couples with the first inner tube; any cross section, vertical to the central axis, of the second inner tube has the first cross-section curvature; the second outer tube couples with the first outer tube; the cross section, vertical to the central axis, of the second outer tube has an identical second cross-section curvature; and the second cross-section curvature is greater than the first cross-section curvature, so that light can be condensed outside the condensing layer.

9. A light source according to claim 8, wherein the light source is a tubular light source.

10. A light source according to claim 8, wherein the light source is a cold cathode fluorescent lamp (CCFL).

11. A light source with a function of condensing light, wherein the light source is provided with a central axis, and comprises:
a radiating area for providing light;
a penetrable layer for enabling light to penetrate through to outside, wherein the penetrable layer comprises a first inner tube and a first outer tube, any cross section, vertical to the central axis, of the first inner tube and the first outer tube has the same first cross-section curvature; and
a condensing layer, which couples to the penetrable layer and together cover the radiating area inside the light source, wherein the condensing layer comprises a second inner tube and a second outer tube; the second inner tube couples with the first inner tube; any cross section, vertical to the central axis, of the second inner tube has the first cross-section curvature; the second outer tube couples with the first outer tube; the cross section, vertical to the central axis, of the second outer tube has a second cross-section curvature; the second cross-section curvature is greater than the first cross-section curvature; the second cross-section curvature of the middle of the light source is smaller than the second cross-section curvature of the both ends of the light source, so that light can be condensed outside the condensing layer.

12. A light source according to claim 11, wherein the maximum distance between the second outer tube of the middle of the light source and the central axis is smaller than the maximum distance between the second outer tube of both ends of the light source and the central axis.

13. A light source according to claim 11, wherein the light source is a tubular light source.

14. A light source according to claim 11, wherein the light source is a cold cathode fluorescent lamp (CCFL).
